(19) United States
(12) Patent Application Publication
(10) Pub. No.: US 2011/0113014 A1
(43) Pub. Date: May 12, 2011

(54) Methodology of Applying Storage and Logistics Center Model to Achieve Business Data Exchange between Systems

(75) Inventors: JIUSONG SHAO, Nanjing (CN); ZHENHUA JI, Nanjing (CN); CHENGGONG GU, Nanjing (CN); LIBIN SUN, Nanjing (CN); CHUNLEI GAO, Nanjing (CN); YUANYUAN DAI, Nanjing (CN); ZHIPENG YUE, Nanjing, Jiangsu (CN); LIANG DING, Nanjing (CN); HAITAO SHI, Nanjing (CN)

(73) Assignee: LINKAGE TECHNOLOGY GROUP CO., LTD., Nanjing (CN)

(21) Appl. No.: 12/942,999

(22) Filed: Nov. 9, 2010

(30) Foreign Application Priority Data
Nov. 11, 2009 (CN) 200910212448.9

(51) Int. Cl. G06F 17/30

(52) U.S. Cl. 707/648; 707/E17.005; 707/E17.044

(57) ABSTRACT

A methodology of applying storage and logistics center model to achieve business data exchange between systems, is based on the storage logistics center model, establishes data storage management center, which receives and saves the data in each business system and sends data extraction request to the corresponding data; Conducts a detailed checking and verification action in the sending and receiving process of aforementioned data storage management center. Comparing with the existing technology and according to the empirical test, the data delivery stem that is based on fragmented data transportation of the logistics center model (the most typical system in the concurrent technology) shows that: performance is increased by 10%, resource consumption is reduced by 30%, system failure rate has dropped 20%, and each process can be controlled.

### CROSS REFERENCE TO RELATED PATENT APPLICATION

The present application claims the priority of the Chinese patent application No. 200910212448.9 filed on Nov. 11, 2009, which application is incorporated herein by reference.

### FIELD OF THE INVENTION

This invention is related to the technology of data processing in the computer and communication field, in particular with a methodology of applying storage and logistics center model to achieve business data exchange between systems.

### BACKGROUND OF THE INVENTION

At present, the data exchange mechanism between each business system uses either direct file form interface to exchange or message form interface to exchange. When the data exchange between each business system happens, if it found there is a missing data in received message, or the number of received data is not consistent with the number of sent data, it cannot determine which side of communication holds the responsibility of this error. A simple data forwarding does not have an effective mechanism to verify whether the receiving and sending data files are complete and correct, it also cannot detect the causes of the issue and the responsibility error if the issue arisen.

### SUMMARY OF THE INVENTION

The invention introduces the logistics processing model, by using a secure mechanism to regulate the data exchange mechanisms and management processes, and the idea of storage logistics to conduct the data exchange method, in particular with the exchange data method for business systems at different levels to solve issues in the actual production process.

The purpose of the invention is to introduce the logistics processing model, by using a secure mechanism to regulate the process of data sending and receiving, automatic transfer and replicate data, and ensure the consistency, reliability and security of data transfer within the data center through a rigorous auditing and verification mechanism, and at the same time, process and reject the abnormal data.

The technical solution of this invention is as follow:
1) The methodology of applying storage and logistics center model to achieve business data exchange between systems includes the following steps:

101) Data storage and management center scan and detect data in each business system at real time, it will generate data collecting report in according to different business' priority and frequency;

102) Analyze the data report in order to generate data extraction sheet and database storage sheet; Data extraction sheet records the property information of the data.

103) Data extraction sheet is added into the queue of data extraction, and extracts data in accordance with the extraction sheet's priority, business characteristics and distribution frequency requirements (for example, the data uploading and downloading of China Mobile's roaming can be defined as high priority and data from fixed landline service can be defined as lower priority that make sure high priority data been processed first when data is transmitted in a variety of services);

104) During the data extraction process, it would establish a connection with the client interface in the service system first, then verify the data that listed on the data extraction sheet, after verification, it will collect the data into the data receiving buffer zone of data storage and management center and then recording the information that was successfully extracted.

105) After the success of data extraction, it can make the approved data to be stored in the database; the mentioned data in the receiving buffer zone would still need to be verified by the database storage sheet, and then it can be stored in the database;
2) The aforementioned stages of using data storage and management center to send data includes are the follows:

201) Develop a data transfer sheet in according to the sending request of business system first, and the information that records in the data sending sheet is the property information of the data;

202) Sending the data to the receiving buffer zone and record the process until the recorded data and the data that were listed on the database output has been verified.

203) The establishment with the destination of business system's client and sending the data to the destination until the data has been verified in accordance with the data sending sheet and its corresponding data in the data sending buffer zone.

Each aforementioned steps 101˜105, 201˜203, has a log record.

The mentioned data storage and management center conducts the life cycle management on a regular base: data within the life cycle will be backup and then the overdue data will be cleaned up; providing a variety of service system line, pie chart and every kind of report in according to the data analysis and research on variety of frequencies.

The mentioned data in the database will integrate the data that share the same business request into a single database output sheet according to the needs of the different business systems, the factors of priority, destination and frequency.

The mentioned priority information of the data extraction sheet (carrier's note) that is mentioned in step 102) includes following steps: record the critical information such as data size, quantity, sources of business and etc. Similarly, the mentioned database storage sheet (invention list), database output sheet (delivery proof), database sending sheet (dispatch list) and other recorded information are all based on the needs of specific application settings. For example,

Database storage sheet (invention list) can record the critical information such as shelf address, data size, quantity, sources of business and etc;

Database output sheet (delivery proof) can record the critical information such as shelf address, data size, quantity, address of sending center and etc;

Comparing with the existing technology, the effect of this invention is: according to the empirical test, the data delivery stem that is based on fragmented data transportation of the logistics center model (the most typical system in the concurrent technology) shows that: performance is increased by 10%, resource consumption is reduced by 30%, system failure rate has dropped 20%, and each process can be controlled.

### BRIEF DESCRIPTION OF THE DRAWINGS

FIG. 1 is the model of storage and logistics center;

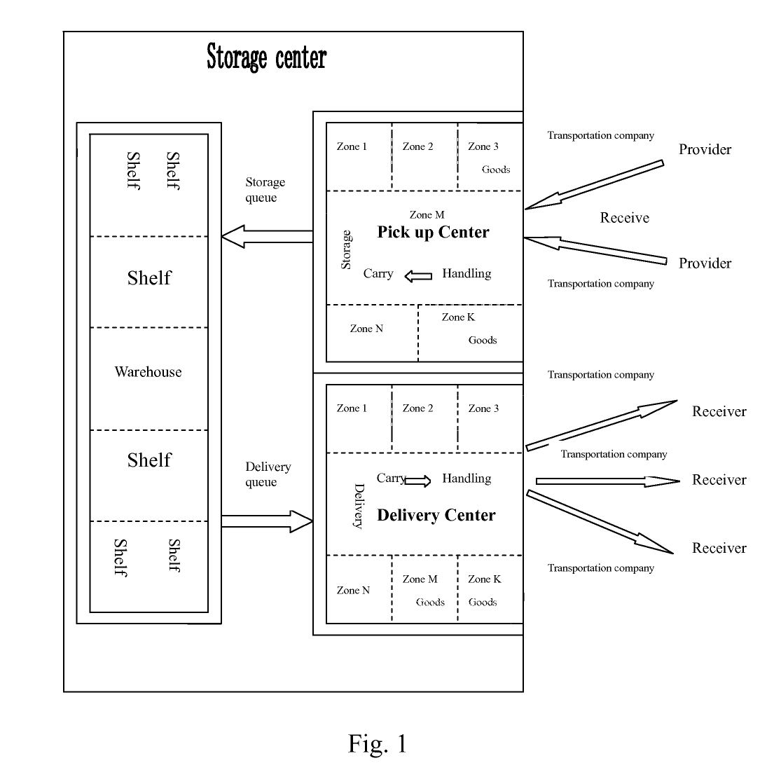

FIG. 2 is operation model of this invention;

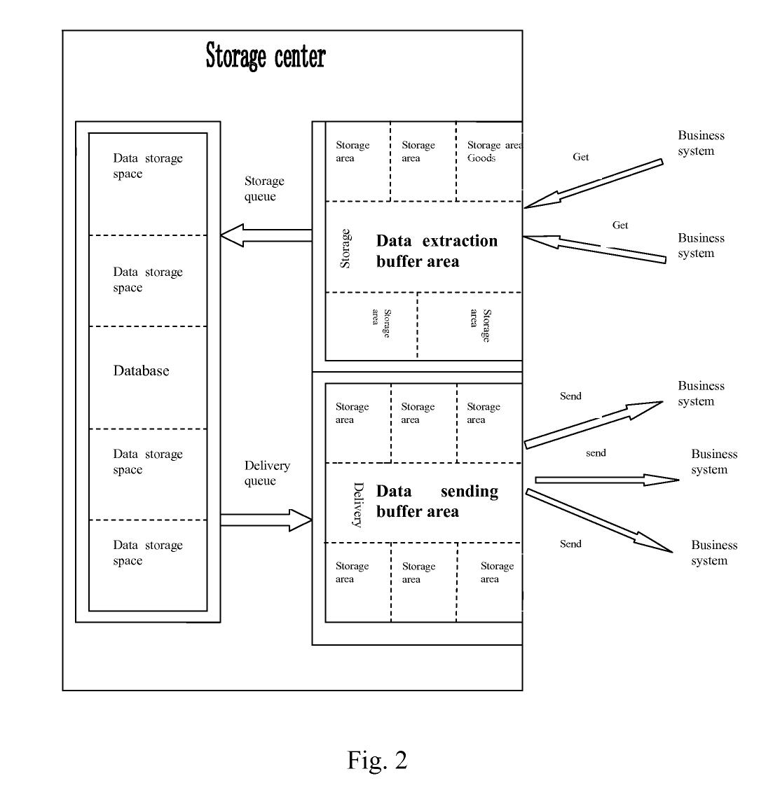

FIG. 3 is control connection and separate illustration of the data connection of this invention.

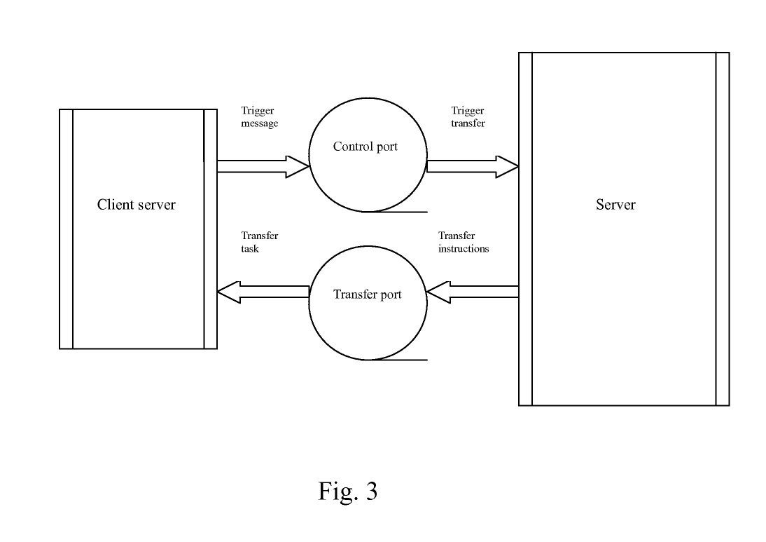

### DETAIL DESCRIPTION OF THE INVENTION

The following paragraphs will use graphs and specific implementation method to make a further illustration for the invention.

The implement components of the system for this invention includes: Scheduling center for data exchange services 1, Business control component 2, Component for controlling and connecting client 3, Component of client database 4, Component for data read and send process 5, Scheduling process component for data input and output database 6, Data storage and management center 7 (including data storage buffer zone, data sending buffer zone, and database). All of the above components and processes can be realized by using the existing programming technology which can be obtained by following the necessary steps of this invention and will not be specified here:

Referring to Graph 1, it is the storage and logistics center which is referred by this method. Graph 2 is a model of this approach. Combining the two models, the invention is described as follows:

The method includes following steps:

1. Logistics client interface would scan and detect data in each business system at real time, it will generate data collecting report in according to different business' priority and frequency.

2. Business control component would analysis the data report in order to generate data extraction sheet (including the size, quantity and business sources etc) for the scheduling center for data exchange services to ensure that all of the collected data is traceable.

3. Scheduling center for logistics data exchange service will add the data extraction sheet into the queue of data extraction and extracts data in accordance with the extraction sheet's priority, business characteristics and distribution frequency requirements

4. Logistics extraction process will establish a connection with the client interface in the service system first, then verify the actual data that is extracted and the data that listed on the data extraction sheet, after verification, it will collect the data into the data receiving buffer zone of data storage of the data recording management center and then recording the information that was successfully extracted.

5. Logistics scheduling center will distribute invention list (record the critical information such as the shelf address, quantity, sources of business and etc) to the logistics storage process, the storage process will verify the data in the storage receiving centre with the inventory list and then collect the data in the shelf of data storage.

6. The data storage and management center conducts the life cycle management for the data in the database storage on a regular base: data within the life cycle will be backup and then the overdue data will be cleaned up; providing a variety of service system line, pie chart and every kind of report in according to the data analysis and research on variety of frequencies, so that the information isolation, different fragmented business services systems and inconsistency issues of It system clusters could be solved.

7. The logistics scheduling center will integrate the data in the database storage that share the same business request into a single database output sheet (records the critical information such as shelf address, data size, quantity, sources of business, address of sending center and etc) according to the needs of the different business systems, the factors of priority, destination and frequency.

8. Logistics inventory input and output process will verify the actual data in accordance with the data in the delivery list, after that data will be delivered to sending center and reply the receipt for logistics center.

9. Logistics center will distribute the delivery list to the logistics delivery process, and logistics delivery process will verify the data with the sending and then establishing the data connection with the business system interface destination. Each step has a log record, the whole logistics exchange process is transparency and controllable.

The following are the characteristics and major advantages for this invention:

1. It solves the issue of the verification shortage of data direct exchange within the same level of business system as well as across different levels of business system.

2. Logistics exchange center model is a data exchange hub for data exchange between systems which considers the business system as a concept of network element, and the data around the network element can use logistics center to exchange and share collectively, it reduces the cost of network element as the interface and saves the valuable host resources, storage resources and network resources.

3. The introduction of the logistics storage management principle refers to a holistic of shipping documents management theory which treats the both parties of data interaction as an independent network element, and it broke the concept of point to point communication and established data tracking, querying and management mechanisms to ensure the integrity of the data exchange.

4. The logistics reference process creates a data transfer link automatically to send the data to the destination network element safely. If the destination network element has not start or cannot work, the logistics center will store file and message temporary. When the network element starts or can work, the temporary file and message will be then transferred to network element, processed by the network element, thus making the transfer much more reliable and easier.

First, the process server in the actual environment:

1. Install logistics exchange services scheduling center, logistics storage data management center and other components on the host server.

2. Distinguish the actual sending and receiving center and the data storage zone in the host server.

3. Active the logistics data exchange center and logistics storage data management system.

Second, client processing server in the actual environment:

1. Install the client program on the business system hosts.

2. Open the corresponding transfer and control interface (for scanning and transferring data) and active the client program on the business system host.

What is claimed is:

1. A method of applying storage and logistics center model to achieve business data exchange between a multiple of systems comprising:
1) the storage and logistics center model has a data storage management center, which receives and saves data from each business system and sends data extraction request to corresponding data, conducts a detailed checking and verification action in the sending and receiving process of the data storage management center;
2) the method of applying storage and logistics center model to achieve business data exchange between a multiple of systems includes the following steps:
101) the data storage and management center scans to detect data in each business system at real time and generate data reports for collected data in according to different business' priority and frequency;
102) analyzes the data reports in order to generate data extraction sheets and database storage sheets; the data extraction sheet records property information of the data.
103) the data extraction sheets are added into a queue of data extraction, extracting data is in accordance with extraction sheet's priority, business characteristic and distribution frequency requirements;
104) during the data extraction process, firstly establishes a connection with client interfaces in the multiple systems, then verifies data listed on the data extraction sheets, after verification collects the data into a data receiving buffer zone of the data storage and management center and then record the data extracted successfully;
105) after the success of data extraction, approved data is stored in a database, the data in the receiving buffer zone is still need to be verified by a database storage sheet then to be stored in the database;
3) the data storage and management center has following process for sending data:
201) develops the data transfer sheet in according to sending request of each business system first, and the information recorded in the data transfer sheet is property information of the data;
202) sends the data to the receiving buffer zone and record the process until exactness is verified for the data in database in accordance with a data output list;
203) establishes data connection with destination clients of the business system and sending data in the buffer zone to destination clients until exactness is verified for the data in the buffer zone in accordance with an data sending sheet;
each one of steps 101˜105, 201˜203 has a log record.

2. The method of applying storage and logistics center model to achieve business data exchange between a multiple of systems of claim 1, wherein the data storage and management center conducts a life cycle management on a regular base; data within the life cycle is backup and overdue data will be cleaned up; providing a variety of service system lines, pie charts and multi-kind of reports in according to the data analysis and research on variety of frequencies.

3. The method of applying storage and logistics center model to achieve business data exchange between a multiple of systems of claim 1, wherein data in the database shared by same business request is integrated into a single database output sheet according to needs of the different business systems, factors of priority, destination and frequency.
